(19) United States
(12) Patent Application Publication
(10) Pub. No.: US 2008/0314935 A1
(43) Pub. Date: Dec. 25, 2008

(54) Dispenser for Laundry Chemicals

(76) Inventor: Mikel David Spargo, Bulli (AU)

Correspondence Address: MICHAEL MOLINS;MOLINS & CO., SUITE 5, LEVEL 6, 139 MACQUARIE ST, SYDNEY NSW, 2000, AU

(21) Appl. No.: 12/097,538

(22) PCT Filed: Dec. 15, 2006
(86) PCT No.: PCT/AU2006/001910

§ 371 Date: Jun. 16, 2008

(30) Foreign Application Priority Data
Dec. 16, 2005 (AU) 2005907122

(51) Int. Cl. G01F 11/20; B65D 88/54

(52) U.S. Cl. 222/413; 222/333

(57) ABSTRACT

Disclosed in this specification is a container and a dispensing mechanism for dispensing various materials into an apparatus such as a laundry machine. The container comprises a dispensing cap that has a static portion and a rotating portion. A relative rotation between the static and rotating portions can be created once the dispensing cap is inserted into a hopper of the dispensing mechanism. This relative rotation discharges the material inside the container into the hopper that in turn discharges the material into a conveyor. The conveyor feeds the material into the apparatus.

### FIELD OF THE INVENTION

The invention relates to chemicals dispensers and more particularly to a chemical dispenser for a commercial laundry machine. It will be understood that the teachings of the invention apply to a wide variety of machines that require manual loading of chemicals.

### BACKGROUND OF THE INVENTION

Large commercial washing machines are used in a multitude of industrial and commercial situations. Front or side loading machines, in sizes from 8 to 500 kilogram capacity are used in industries, hotels, motels, gaols, nursing homes as well as commercial and military laundries. Detergents and sundry chemicals are fed into these machines as either powders or liquids. The powders or liquids may be introduced into the machines either manually or automatically. All prior art methods feed either into a soap box or into a liquid feed point located at the rear of the machine. Soap boxes are not present on all machines. Some machines are so large that, for practical purposes, only liquid chemical feeders are installed.

Soap boxes consist of three or more compartments located at the front, side or top of a typical washing machine. The soap box is covered by a flap or door to stop the chemical and flush water from inadvertently coming out of the machine. Soap boxes are very humid environments because the pipe work from the box goes directly into the washer. Thus, steam and humid air are able to pass directly into the hopper or hoppers of the soap box.

Manually feeding powder into a soap box is considered a sub-optional solution. Manual feeding of dry powders is time consuming, hazardous, messy and potentially expensive. Manual dosing runs a risk that an operator will forget to load the powder into the soap box. This requires a re-wash. A re-wash not only wastes the hot water from the first wash but often requires more detergent than was required in the first.

Manual liquid feeding is subject to the same risks and potential costs.

Automatic liquid feeding delivers liquid chemicals into the washing machine via injection points in the soap box or directly into the water supply. Liquids are often dispensed through peristaltic pumps that are controlled from programmable control boards that vary the times that the pumps run, providing different doses, as required. Automatic liquid feeding eliminates many of the risks associated with operator error and eliminates some of the hazards associated with decanting and measuring hazardous chemicals. However, automatic liquid feeding is considered expensive, particularly in the labour required to install automatic liquid feeding equipment. Installation of this type of equipment requires a relatively high degree of knowledge in the programming of the control boards. Because of chemical attack on the pumps and the tubing, frequent maintenance is sometimes required. Further, liquid cleaning products are stronger than conventional detergents and particular care is needed when changing chemical drums. Handling requires personal protective equipment and liquid spills become a workplace safety issue in areas where the consumption of liquid chemicals is high.

Automatic powder feeding involves the use of containers or capsules having a gauze or grid cap in which are located four kilogram amounts of detergent or chemicals. The containers are turned upside down into a hopper or holder. When detergent is required, the automatic dispenser receives electronic signals from the machine that it feeds. It is plumbed into the water supply so that a spray or jet is introduced into the upturned capsule, as required. The water spray dissolves the powder, which falls to the bottom of the hopper and into a hose that leads into the machine. Gravity conveys the detergent into the washing area. Automatic powder feeding as it is currently known has several drawbacks. Devices of this type are not very accurate as volumetric feeders and the delivered dosage can vary considerably. This results in inconsistent, sometimes poor results. Further water sources found within a laundry are subject to varying water temperature and pressure at different times if the day. These changing conditions alter the feed rate and dosage of the detergents and chemicals giving inconsistent or poor results. Automatic powder feeders are considered inaccurate and are also associated with workplace hazards, particularly when the protective travel caps are removed from the capsules. The risks associated with inhalation of and skin contact with laundry chemicals cannot be ignored.

While the information provided above applies to a wide range of industrial and commercial laundry situations, the same risks and limitations apply to other types of machines where dry powders of a hazardous nature are dispensed or dosed on a regular basis particularly in humid or otherwise hostile environments.

### OBJECTS AND SUMMARY OF THE INVENTION

It is an object of the invention to provide an automatic volumetric feeder for powders that can deliver into a humid or hostile environment.

It is another object of the invention to provide a volumetric powder feeder for use in laundries.

It is another object of the invention to provide a container that reduces the health hazards associated with the loading of powder feeders.

It is yet another object of the invention to provide a combination of dispenser and container that find utility in environments such as laundries or other localities where powdered chemicals are dispensed.

Accordingly, there is provided a container having a dispensing cap. The dispensing cap comprises a static portion and a rotating portion. Both the static portion and the rotating portion of the dispensing cap have openings that align to provide a path for a powder to flow through. Also provided is a dispenser that is adapted to receive the inverted container and dispense the contents of the container using an internal screw conveyor. In preferred embodiments, air is discharged into a central bore of the screw conveyor, the air being expelled into an area where the powder is discharged so as to maintain that area in positive pressure.

### BRIEF DESCRIPTION OF THE DRAWING FIGURES

FIG. 1 is a cross sectioned side elevation illustrating a dispensing container and dispenser device in accordance with the teachings of the present invention;

FIG. 2 is an exploded perspective of the device depicted in FIG. 1;

FIG. 3 is a perspective view of the hopper and dispensing tube depicted in FIGS. 1 and 2;

FIG. 4 is a perspective view of a container and dispenser cap of the type depicted in FIGS. 1 and 2;

FIGS. 5(a) and (b) are a plan view and side elevation of the static portion depicted in FIG. 4;

FIGS. 6(a) and (b) are a top plan view and side elevation of the rotating part depicted in FIG. 4;

### BEST MODE AND OTHER EMBODIMENTS OF THE INVENTION

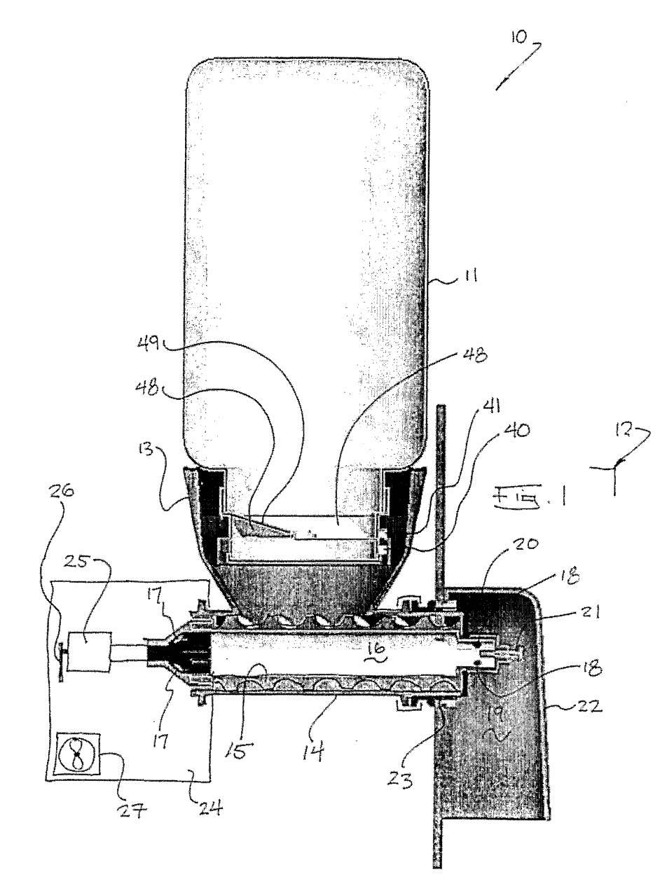

As shown in FIG. 1, a powder feeder assembly comprises a specially adapted container 11 that cooperates with a dispensing mechanism 12. As will be explained, the interaction between the container 11 and the dispensing mechanism 12 ensures that users of the apparatus are not exposed to excessive airborne particulates while the dispensing mechanism is being loaded or when the container 11 is removed from the dispenser. Further, the dispenser is configured to dispense accurate quantities of powder, as required, without being adversely affected by humidity.

With further reference to FIGS. 1 to 3 the dispensing apparatus 12 comprises a hopper 13 that discharges into a feed apparatus 14, in this example a feed cylinder, within which is located a screw conveyor 15. In preferred embodiments, the screw conveyor 15 is hollow having a central bore 16. Inlet openings 17 at one end of the screw conveyor 15 admit pressured air into the bore 16. Air can be supplied constantly through the hollow conveyor 16, exiting through vent openings 18 formed at an opposite end of the conveyor screw 15. In this way the area 19 where the dry powder is dispensed is maintained at a positive pressure, preventing the ingress of humid air into the discharge end of the conveyor cylinder 14. In further preferred embodiments, the open discharge end of the conveyor cylinder 14 is covered with a VITON or other polymeric washer 20. Rotation of the screw conveyor causes the outer edge of the washer 20 to flex thereby discharging powder from around the periphery of the tube 14. The distal end of the screw conveyor 15 further comprises an adjustable spacing screw 21 that forms in adjustable length bumper. During installation procedures, the length of the adjustment screw 21 can be adjusted manually to limit the extent of axial travel of the screw 15.

Note that the conveyor tube 14 is mounted through an opening 23 formed in an external wall of a washing machine or other apparatus. A cowl or chute 22 covers the discharge end of the conveyor. The other end of the conveyor tube 14 carries a housing 24 within which is located the conveyor's motor 25. The motor 25 or its shaft may be provided with an eccentric weight 26 so that the entire assembly 11, 12 vibrates whenever the motor is rotating. The housing 12 also contains the ventilation fan 27. Continuous operation of the fan 27 ensures that an air supply is introduced into the openings 17 associated with the driven end of the screw conveyor 15.

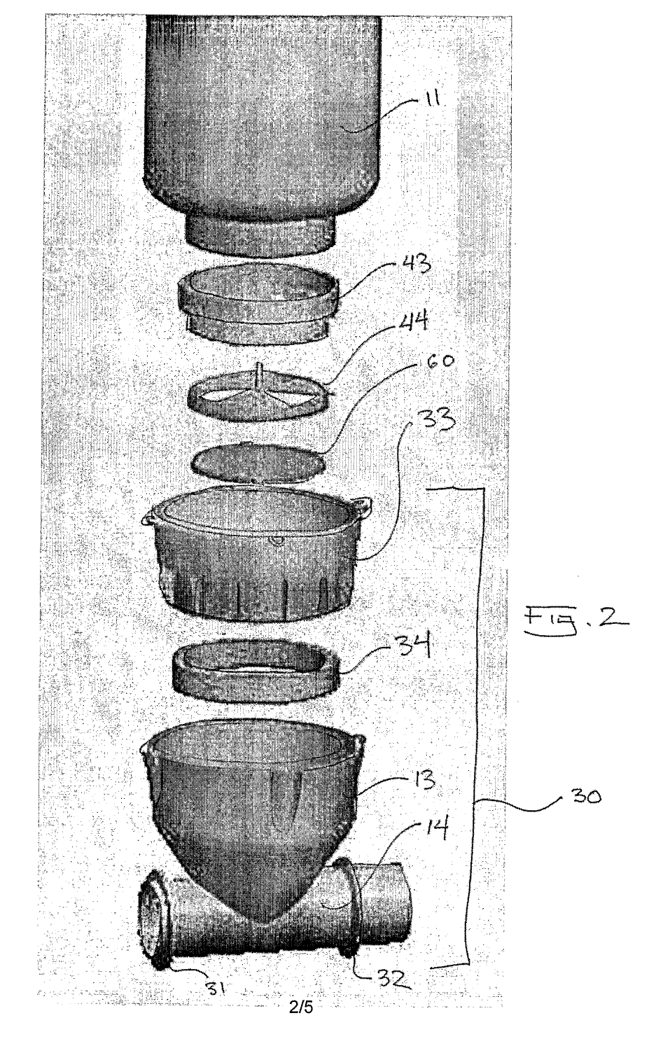

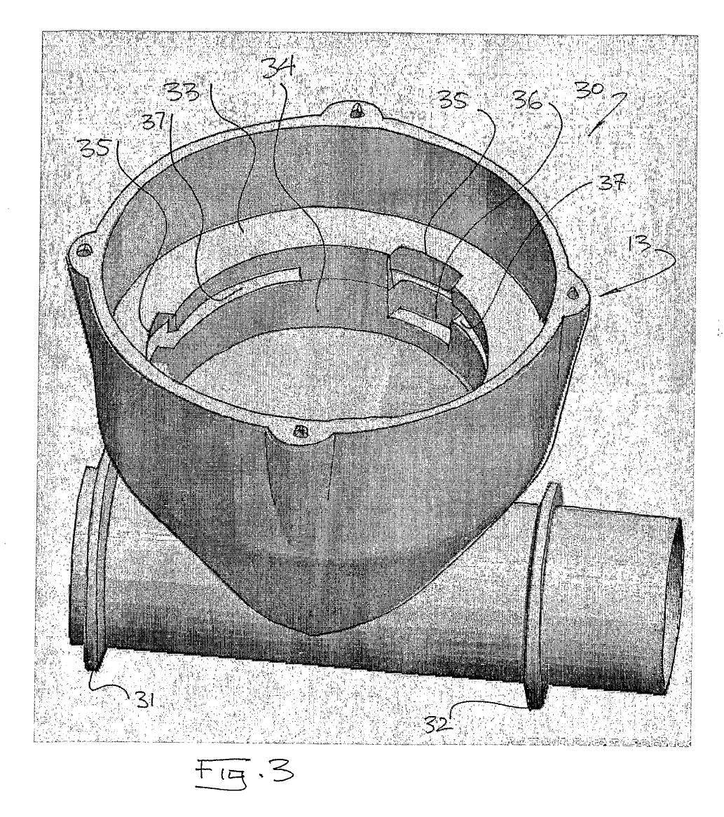

As shown better in FIGS. 2 and 3, limitations in plastic moulding technology require that the principal non-moving portions of the dispensing body be fabricated separately, than integrated by assembly. Note that the dispenser body 30 is able to utilise an optional single moulding that incorporates both the exterior of the hopper 13 as well as the conveyor tube 14. The conveyor 14 includes integral flanges 31, 32 that are used in the attachment of the motor and fan housing 24 and in the attachment to the wall of the washing machine. Note that the main body of the hopper 13 receives a sleeve-like annular liner 33 below which is located a capture ring 34. As shown more clearly in FIG. 3, both the liner 33 and capture ring 34 include notches 35, 36 that are in alignment when the device is assembled. There must be at least one pair of aligned notches 35, 36 but the invention also permits the use of two or more pairs of notches 35, 36. In the present example, and as will be further explained, three pairs of notches 35, 36 are used in conjunction with a particularly configured dispensing cap on the container 11. Altering the size, spacing and number of notch pairs 35, 36 allows for a particular dispenser to receive only a particular cooperating container 11 and therefore only a selected chemical or family of chemicals.

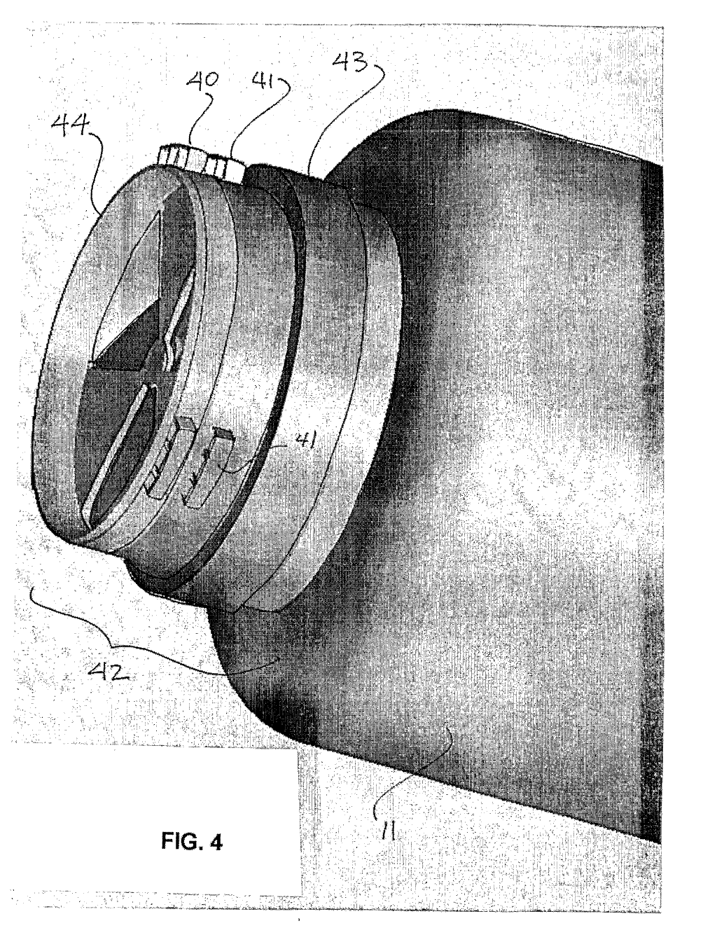

The configuration of the notches 35, 36 serves several purposes. The aligned notches 35, 36 admit the entry of the aligned tabs 40, 41 associated with the dispensing cap (see FIG. 4). The tabs 40, 41 extend radially beyond a nominal radius of the dispensing cap. The corresponding tabs 40, 41 are carried by ports of the dispensing cap. With reference to an inverted container, the upper port of the cap is a static sleeve 43 and the lower port is a rotating diaphragm 44. The lower of the two notches 36 captures the lower of the two tabs 40 and prevents the diaphragm 44 from spinning. However, the upper notch 35 leads directly into a portion of a female thread 37. When the container 11 is fully inserted into the hopper 13, the upper of the two tabs 41 is able to enter the thread area 37 when the container 11 is rotated. This action causes the differential rotation of the sleeve 43 with reference to the lower diaphragm portion 44. This causes the dispensing cap to open or close, but only when it is within the hopper 13. Further, the initial movement of the upper tab 41 within the thread 37 causes the container 11 to advance down into the hopper. This creates a sealing engagement between the shoulder of the container 11 and the upper rim of the hopper 13 as shown in FIG. 1.

As shown in FIG. 4, beneficial interactivity between the container 11 and the dispensing apparatus 12 is facilitated by the dispensing cap 42. FIG. 4 illustrates the dispensing cap 42 as further comprising a static sleeve component 43 and a rotating diaphragm 44. The sleeve component 43 is uppermost when the container 11 is inverted. The sleeve component 43 is either screwed onto the neck portion of the container 11 or is affixed to it permanently e.g. by ultrasonic welding or adhesives.

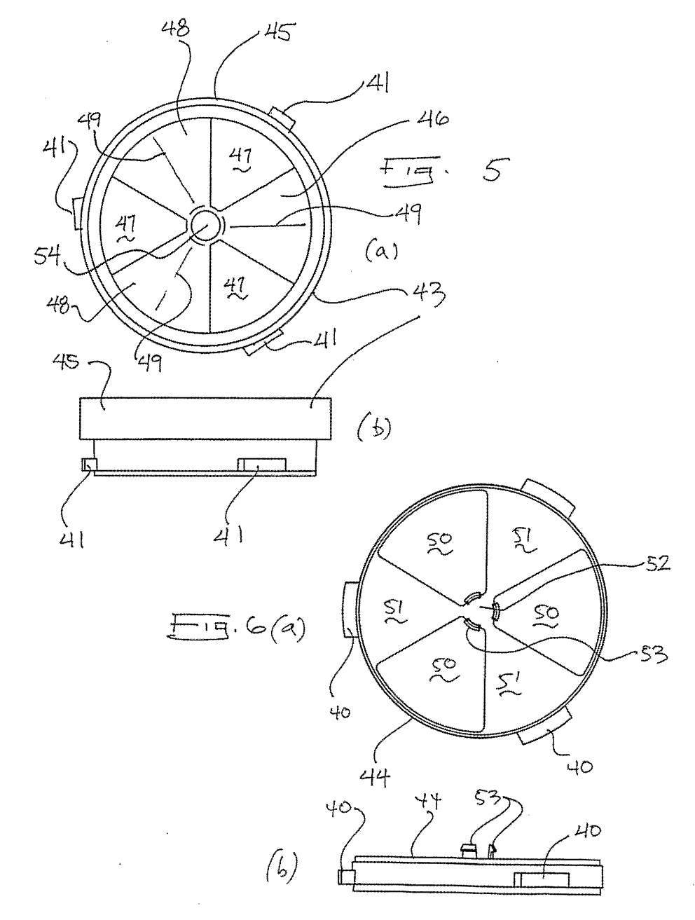

As shown in FIGS. 4, 5(a) and 5(b), the sleeve component 43 includes an attachment flange 45 within which may be located the threads for connecting the sleeve component to the container 11. The circular opening defined by the flange 45 is occupied, in part, by a web 46. The web 46 occupies approximately 50% of the cross sectional area of the effective opening and thus, in this example, forms three distinct openings or passageways 47 through which powder can descend into the hopper 13. The solid portions of the web 46 form triangular or wedge shaped blocking portions 48. Each of the blocking portions 48 has a centrally located ridge 49 that essentially subdivides the area of the blocking portion 48. Thus, adjacent blocking portions 48 form a funnel shape leading into each of the openings 47. Thus powders flow more easily through the openings 47. Powders falling through the openings 47 encounter the rotating diaphragm 44. As shown in FIGS. 4, 6(a) and 6(b), the rotating diaphragm 44 further comprises discharge openings or passages 50 separated from one another by second, flat blocking portions 51. The central hub 52, in this example, comprises three resilient fingers 53 that snap into the central opening 54 of the sleeve portion 43. Thus, the diaphragm 44 is able to engage and rotate with respect to the sleeve portion 43. When the second discharge openings 50 are in alignment with the first discharge opening, powder flows through the openings 47, 50.

In operation, and with reference to each of the drawing figures, the dispensing mechanism is loaded with dry powder by first removing the protective cap 60 from the rotating diaphragm 44 of the dispensing cap. The user should observe that the tabs 40, 41 (regardless of their number) are in alignment, thus ensuring that the discharge openings 47, 50 are not in alignment. When the tabs 40, 41 are in alignment, the blocking portions 48 cover the discharge openings 50 formed in the diaphragm 44. In this orientation, the container 11 is inverted and inserted into the hopper 13. Because the tabs 40, 41 are in alignment, they will enter the aligned notches 35, 36 formed in the interior of the hopper. Once fully inserted, the container 11 is rotated. Because the diaphragm's notches 40 are captured by the lower notch 36, the diaphragm will remain stationary with respect to the hopper 13 but will be seen to be rotating with respect to the sleeve portion 43. The sleeve portion 43 is able to rotate because its tabs 41 will rotate into the threads 37 formed into the interior of the hopper 13. This will cause both the container 11 to descend further into the hopper and will cause the discharge openings 47, 50 to come into alignment. This will allow dry powder to fall into the hopper whereupon it can be conveyed by the screw conveyor 15 into the discharge area 19. In other words, the container is opened when it is rotated and installed into the hopper.

While the present invention has been disclosed with reference to particular details of construction, particularly the number and configuration of the cooperating notches and tabs, container shape, container size and other details of construction, these should be under understood as having been provided by way of example and not as limitations to the scope or spirit of the invention.

What is claimed is:

1. A container for a dispenser, comprising:
a container having a dispensing cap attached to it, the dispensing cap further comprising a static portion and a rotating portion;
the static portion carrying a tab, and the rotating portion carrying a cooperating tab;
the static and rotating portions having openings that are adapted to align or not depending on an orientation of the rotating portion;
the tabs facilitate a turning of the rotating portion relative to the static portion.

2. The container of claim 1, wherein,
the tabs extend radially past a nominal diameter of the cap.

3. The container of claims 1 or 2, further comprising,
a web partially occupying an opening defined in the static portion, the web having formed in it one or more passageways, there being a plurality of first blocking portions, each first blocking portion being located between two adjacent passageways.

4. The container of claim 3, wherein,
each first blocking portion comprises a central ridge, wherein two adjacent first blocking portions form a funnel shape.

5. The container of claims 3 or 4, wherein,
the rotating portion further comprises a rotating diaphragm that has formed in it a plurality of discharge passages, there being a second blocking portion located between two adjacent discharge passages.

6. The container of claims 4 or 5, wherein,
the rotating diaphragm further comprises a central hub adapted to snap into the central opening of the static portion.

7. The container of any one of claims 4 to 6, wherein,
the first blocking portions are adapted to cover the discharge openings when the tab and the corresponding tab carried by the dispensing cap are in alignment with each other.

8. A feeder assembly, comprising:
a container further comprising a dispensing cap;
the dispensing cap further comprising a static portion and a rotating portion, wherein rotating the container during an installation of the container into the hopper opens the container;
a dispensing mechanism further comprising a hopper that is adapted to receive the dispensing cap; wherein
the hopper discharges into a feed apparatus, the feed apparatus containing a motorised conveyor.

9. The feeder assembly of claim 8, wherein,
the conveyor further comprises a first end that has formed in it an air inlet, an opposite end that has formed in it one or more vent openings, and a central bore between the first and opposite ends.

10. The feeder assembly of claim 9, wherein,
the first end of the conveyor carries a housing in which is located a ventilation fan that introduces an air supply into the air inlet.

11. The feeder assembly of any one of claims 8 to 10, wherein,
the hopper comprises a main body that receives an annular liner and a capture ring.

12. The feeder assembly of claim 11, wherein,
one or more tabs carried by the static portion are received by one or more notches formed in the annular liner, and one or more tabs carried by the rotating portion are received by one or more notches formed in the capture ring.

13. The feeder assembly of claim 12, wherein,
the one or more notches formed in the capture ring lead into a female thread.

14. The feeder assembly of any one of claims 8 to 13, wherein,
the hopper and the feed apparatus are made from an integral moulding.

15. The feeder assembly of any one of claims 12 to 14, wherein,
a downward movement of the tabs creates a sealing engagement between the container and the hopper.

16. The feeder assembly of any one of claims 8 to 15, wherein,
the conveyor is a screw conveyor.

17. The feeder assembly of any one of claims 8 to 16, wherein,
the motorised conveyor further comprises an eccentric weight that causes the feeder to vibrate.
